(19) United States
(12) Patent Application Publication
(10) Pub. No.: US 2002/0184203 A1
(43) Pub. Date: Dec. 5, 2002

(54) Process for electronically marketing goods or services on networks of the internet type

(75) Inventors: Chahab Nastar, Paris (FR); Jacques Feldmar, Montmagny (FR); Sebastien Gilles, Paris (FR); Alexandre Winter, Paris (FR)

Correspondence Address: SCHNADER HARRISON SEGAL & LEWIS, LLP, 1600 MARKET STREET, SUITE 3600, PHILADELPHIA, PA, 19103

(73) Assignee: LTU Technologies, Paris (FR)

(21) Appl. No.: 10/171,265

(22) Filed: Jun. 13, 2002

Related U.S. Application Data
(63) Continuation of application No. PCT/FR00/03563, filed on Dec. 15, 2000.

(30) Foreign Application Priority Data
Dec. 16, 1999 (FR) FR 99//15903

(51) Int. Cl. G06F 7/00

(52) U.S. Cl. 707/3

(57) ABSTRACT

A process for presenting information in a multimedia file from a query implemented by a user on an open computer network including a multiplicity of computer terminals enabling transmission of graphical data displayed in multimedia files, the process including selecting at least one image comprising an object to be retrieved, adaptively analyzing a global image to isolate a zone of interest comprising a graphical element which is an object of a query and calculating a set of visual signatures for each object, comparing visual signatures of extracted objects and images contained in the multimedia files to find similar objects stored in the multimedia files, and constructing a file including a set of responses resulting from the comparison.

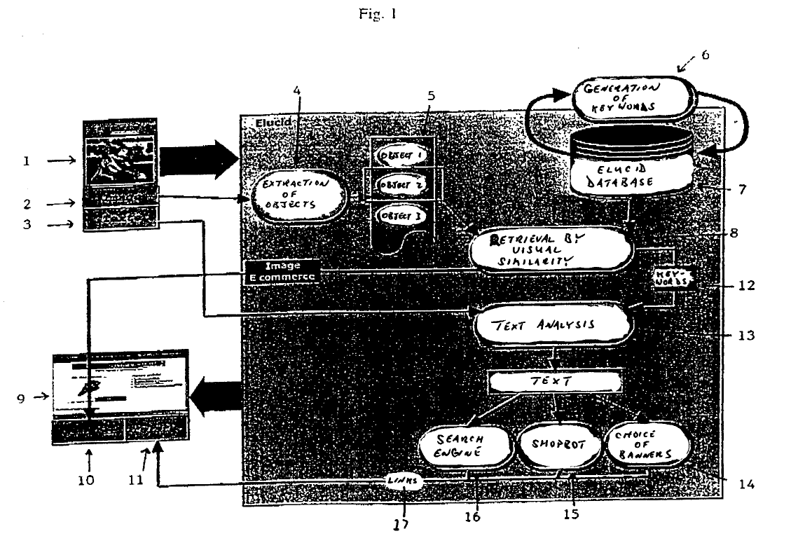

### RELATED APPLICATION

This is a continuation of International Application No. PCT/FR00/03563, with an international filing date of Dec. 15, 2000, which is based on French Patent Application No. FR 99/15903, filed Dec. 16, 1999.

### FIELD OF THE INVENTION

This invention relates to the domain of the dissemination of information and data and the marketing of goods or services by electronic means on networks of the Internet type.

### BACKGROUND

Web browsers provide the Internet network with graphical interfaces facilitating access and use of this communications network. One expanding use of this network comprises its transformation into commercial means, thereby opening the way to new ways of selling goods or services.

Sales services are presently concentrated on specialized sites which can be strictly dedicated to transactions or can offer complementary free services. A large number of companies market their products on their Internet sites. Search engines integrate the commercial data and enable locating a specific product.

In all of these cases, the offered systems are based on the assumption that the user must implement an active step for the purpose of making a purchase. The user either goes to a specialized site or searches for a specific product. The interactivity provided by the computer means used is not yet optimized to enable impulse purchases at all times. When the user displays the Internet pages of a noncommercial site comprising a product that could be of interest, the user has no means to identify the brand or distributor of this product, or to make an online purchase.

The graphical presentation of the Internet multiplies potential temptations and cravings because of its visual richness. However, it is presently incapable of instantaneously transforming an impulse into a purchase opportunity.

If the Internet surfer wants to acquire the object of attraction, the user has to launch a lengthy, uncertain process because the content sites and the commercial sites are not linked.

Image retrieval processes are known in the state of the art. The article “Region queries without segmentation for image retrieval by content” published in the proceedings of the “3^{rd} International Conference on Visual Information Systems, VISUAL 99”, Amsterdam, Jun. 2-4, 1999, pages 1-8, describes an image retrieval process based on region of interest, employing a systematic image cut-out step according to an identical cut-out format for all of the images. Recognition is implemented by comparison of the content of each element of this cut-out. This type of solution does not makes possible recognition of an object in the image independently of its position in relation to this image.

U.S. Pat. No. 5,758,324 concerns an image retrieval process based on analysis of annotation text information pertaining to said images. This process does not allow retrieval of images that have not been prepared, i.e., images that have not been the object of an initial referencing.

The article “Relevance feedback and category search in image databases” published in Proceedings IEEE Multimedia Systems 99, Florence, Jun. 7-11, 1999, pages 512-517, vol. 1, describes an image retrieval process based on successive refining of queries in order to find images of a given category.

This type of solution requires an interaction phase with the user to determine the degree of proximity of the images in relation to the choices of a human operator. This solution does not enable automation of the retrieval process for a new category of images.

It would accordingly be advantageous to provide an improved, totally automated image retrieval process which resolves the drawbacks of the state-of-the-art processes.

### SUMMARY OF THE INVENTION

This invention relates to a process for presenting information in a multimedia file from a query implemented by a user on an open computer network comprising a multiplicity of computer terminals enabling transmission of graphical data displayed in multimedia files, the process including a) selecting at least one image comprising an object to be retrieved, b) adaptively analyzing a global image to isolate a zone of interest including a graphical element which is an object of a query and calculating a set of visual signatures for each object, c) comparing visual signatures of extracted objects and images contained in the multimedia files to find similar objects stored in the multimedia files, and d) constructing a file comprising a set of responses resulting from the comparison.

### BRIEF DESCRIPTION OF THE DRAWING

The sole figure is a schematic representation of selected aspects of the process of the invention.

### DETAILED DESCRIPTION

This invention pertains to a commercial offering presentation process making it possible to propose a product similar to the object whose representation is visible on the page of the site which triggered the purchase decision.

The invention includes a process for presenting information in a multimedia file from a query implemented by a user on an open computer network comprising a multiplicity of computer terminals enabling transmission of graphical data displayed in multimedia files, the process comprising a step of a query keyed in by the user consisting in the selection of an image comprising at least one object, a query processing step, a database interrogation step based on this query, a step of constructing a file comprising the set of responses associated with this query, characterized in that

the processing step comprises extracting the objects contained in the specific image, and

the database interrogation step comprises comparison of the objects contained in the specific image with those contained in said database.

The extraction step is a step comprising adaptive analysis of the global image to isolate a zone of interest containing a graphical image which is the object of the query.

There is advantageously defined a specific zone which is determined substantially automatically in a manner specific to each image analyzed. In contrast to the state-of-the-art solutions, this specific zone is not constant and invariable for the set of images. The cut-out does not require a model defined in advance, but is recalculated in relation to the specificities of each of the images analyzed.

In one variant, a set of visual signatures is calculated for each object.

The interrogation of the database preferentially comprises a step of comparing the visual signatures of the extracted objects and the images contained in the database to find the similar objects stored in the database.

A set of keywords is advantageously associated with each object stored in the database. The file containing the responses to the user's query comprises keywords associated with the set of objects that are similar to the objects extracted from the specific image. On this basis, it is possible to interrogate text databases using the keywords associated with the set of objects similar to the objects extracted from the specific image. It is also possible to interrogate text databases using keywords defined in the query specified by the user.

The invention also concerns the interface comprising image delimitation means and image transmission means for implementation of the previously described process.

The Drawing illustrates the route of the Internet surfer who wants to advance from a content page to a commercial site. The process according to the invention sends the user directly to the site related to the center of interest.

When consulting a specific Web page (1), the Internet surfer can be interested by an object contained in an image (2). The user then transmits this image or a part of this image to an object extraction program (4) which can be on the user's terminal or on a specific server. This extractor (4) enables definition of the set of objects contained in the transmitted image (5). Analysis is performed in real time for images designated by the cursor. The objects from the image are identified as entities and appear, for example, as highlighted. The Internet surfer can define a specific zone of the image in which the product that interests him is located to accelerate image processing.

This extractor (4) then transmits the found objects to the image retrieval mechanism (8). This mechanism preferentially uses retrieval methods based on visual similarities. The objects whose appearance is close to the selected object are considered to be similar. Similarity can be applied to an entire image, e.g., a bouquet of flowers, or to particular objects, e.g., one flower from the bouquet.

The content-based image retrieval principle consists of calculating for each image a set of visual descriptors referred to as visual signatures. These signatures constitute a representation of the information that passes through the human eye in the images and are obtained by an analyzer sensitive to particular visual properties such as color, form and texture. They are represented in a compact manner and in a form that makes it very easy to measure the similarity between the content of two images.

When the extractor (4) presents a new object, the system calculates the signature of this object and compares the new signature with the signatures present in the database (7) to present the user with the database images that are visually the most similar (9).

Two families of visual signatures can be distinguished:

Generic: hey are suitable for all types of image and do not require prior knowledge of the content of the image.

Specific: dedicated to the analysis or recognition of particular images, they are used in a clearly determined application context such as face recognition at present.

One major advantage of the process according to the invention is to be able to divide images into zones corresponding to the objects in the image. Thus, in order to store in the database the signature attached to the complete image, each object present in the image and its associated signature can be stored.

On the basis of the process of the invention, it is possible from any image, whether it be video, Web-TV or the like representing one or more objects to directly access the commercial sites that sell similar objects or objects corresponding to the same family. Any site can thereby become a shop window.

In a complex image containing multiple objects and/or people, a user employing global comparison methods can only retrieve several elements, but can not be certain to find exactly the object being sought after.

In contrast, by means of object extraction, the object is extracted from the requested image as well as all of the images from the database that contain it. The corresponding subimage will be found in the database (7) because in this case the object is represented there.

A user searching for images of a celebrity only has to click on the celebrity's face in the second image. This capability of extracting objects from the scene containing them is unique.

Selection of the zone of interest can also be performed by means of an application program enabling an operator to specify a region of an image containing the object of interest using a graphical market controlled with a conventional peripheral device. The zone thereby selected constitutes the request for analysis of the image database.

To find an image of an object, a user types the name of this object in a conventional search engine. Thousands of images are present on the Web each day without any keywords associated with them. It is, therefore, difficult for the user to find images of the object that he is looking for. It is, of course, inconceivable to manually index all of the images on the Web.

The technology for keyword generation (6) from within the database (7) responds to this problem. In one example selected for illustration, the database contains the object “World Cup” and the keyword “World Cup” was manually attached to the corresponding subimage. Upon addition to the database of a new image containing a specific object, the system proceeds in the following manner:

1. The image is divided into zones corresponding to the objects.

2. For each object, the system retrieves the visually similar objects in the database (7).

3. The system then attaches keywords to the objects of the new image by duplicating the keywords attached to the similar objects already present in the database. The keyword is thereby automatically attached to the zone of the new image.

This keyword generation technique makes it possible to complete the search after having found similar images by visual similarity (8). The similar images are directly displayed in the response page (9) while the keywords (12) attached to the found images are transmitted to the text analysis module (13) which enables interrogation of the text search engines (17) and the merchant sites (15).

The process according to the invention is applicable to all types of sites, to portals as well as to Web-TV and in a general manner to any digital image whether it stems from a scanner, a video camera or a photographic device, and especially originating from the coupling between a digital video camera and a cellular phone.

The process according to the invention can use different types of structures for managing the relationships between the user and the query server.

In a first variant in which the links can be established in advance, use is made of documents residing on a server site providing access to multimedia data. The similar object retrieval service is thus directly available. Recognized objects are highlighted. The Web surfer clicks on the object of interest to access the site as can be done with images using a predefined mapping.

In a second variant, use is made of a downloadable plug-in module in which the links are calculated on the fly. In this case, the retrieval by similarity can be applied from sites without any particular relationship with the site on which is located the database comprising the known images. This is thus a predilection tool for reaching affiliation programs because no agreement is required for indexing a commercial site.

In both cases, when the Internet surfer clicks on the product of interest, the program opens a specific transaction window which immediately connects to the recognition site which offers:

At left, the product.

At right, the products and services related to this product.

The Internet surfer selects a product and is sent directly to a commercial site where a purchase can be made.

The left and right parts of the transaction window play very different but complementary roles. Similar images are presented at the left while at the right are objects corresponding to the product theme.

The preceding description concerns a mode of implementation in which the graphical object extraction step is performed in real time during the loading of the page containing said graphical object. It pertains to a process for the selection of objects in an image, retrieving similar objects, retrieving keywords and interrogating search engines with these keywords. These information elements (similar images with links, similar keywords with links) were initially represented in a pop-up window for the Internet surfer. This process is intended for the final user.

The invention can also be implemented in a different form comprising a graphical object processing and extraction step at the source.

According to this variant which is more specifically intended for the owner of a content image and designed to make a normal image into an active image, i.e., to generate links to commercial sites on the image zones.

This active image is coded in a multimedia document comprising object coordinates as well as links to sites pertaining to similar objects (left part of the original pop-up display) or similar domains (right part of the same pop-up display). This variant provides at least the following multiple noteworthy advantages:

system performance is improved because it is unnecessary to retrieve similar images and subjects each time that an image is activated. This retrieval needs to be performed only once—during the initial recording of the image—and then to transform the image into an activatable which can be transmitted directly to associated sites or images; and

permits the owner of the image to select the links to which he wants the image to point.

The process thus becomes a tool which transforms a passive image into an active image which the owner of the image can influence by activating or deactivating certain parts of the image and/or certain links.

Concerning the display process for the similar objects and links, the initially described process (creation of a page with on one side the similar objects and on the other side the keywords associated with the objects) becomes in this extension intended principally for the owners of images. The invention thus provides to the owner a multimedia document comprising the description of the objects (coordinates, clickable zones) and the corresponding links to similar objects and/or associated subjects. The representation and use of the links of the active image provided is under the control of the owner of the source image.

Selection among the links by the owner of the image is a key part of this variant of the image. It effectively allows the owner of the image to select target sites on the basis of various criteria, including particularly financial criteria (money earned for the owner by the target sites).

This switching station can be modeled using a matrix in which the abscissas are the content sites and the ordinates are the commercial sites. Each owner activates in the appropriate column the commercial sites to which to send selected Internet surfers. Each commercial site can see there which content sites point to it.

It is possible to apply the same similar image retrieval principle to sources other than Internet pages. A digital camera, a PC video camera or a digital GSM device can pick up images of everyday life, transfer them to the network (with or without the use of a PC) and retrieve objects that resemble it. The user of this functionality would use the part intended for owners of images to find links to similar images or similar domains (via keywords).

The invention can be implemented in the form of a technical platform performing the processing of pages for extracting and processing graphical objects.

This platform provides a service to its users allowing them to associate an image with a set of similar images accessible on the Internet. This association set is managed by means of a database located on the technical platform and accessible via the Internet or located in the user's facility with updating performed by the technical platform via the Internet.

A computer program allows performance of three database actions:

addition of an image to the database (ADD).

deletion of an image from the database (DELETE).

retrieval of a URL set of similar images (RETRIEVE).

The ADD and DELETE Procedures: Explicit or Automatic Call Up

Let us take the example of an Internet galaxy in which all of the site images of this community are actively subjected to the mechanism described above.

When client sites add or delete images from their site, they call up the ADD and DELETE procedures. The calling up of these procedures can be explicit or generated by a robot provided by the technical platform, storing in memory the branching of the site's images and automatically notifying (by means of the ADD and DELETE procedures) the technical platform database of any changes.

Upon each ADD procedure, the client site receives a Map image and the structured information so that it can easily be processed. The image of the client site is then replaced on the site by the Map image and the associated information. It can be envisaged that this replacement be automated.

The RETRIEVE Procedure

When a user visits a client site A, a graphical notification allows the user to ascertain that the image is activatable. When the user clicks on the image in question, a RETRIEVE request is issued, then the response (probably an XML file sent by the technical platform) is processed and issued in page form by the site. The user can then click on one of the sites that are offered, which will take the user to a target site. Management of the passage from one client site to another: the URL filter.

The technical platform offers the possibility of filtering the URLs offered or which can be offered by the technical platform, either at the level of the database or the client site. This filter makes it possible to limit the number of URLs of similar images offered to the user. The URLs provided will enable passage from the client site to the sites referenced by the URLs. It is therefore essential that the client have control over these links and thus to be able to decide to which sites to allow clients to be sent.

As a function of the transactions implemented by the users after quitting the client site, this site can negotiate with each of the other sites affiliated with the service the financial conditions of the passage.

Click-through and Per-sale Events

When a client passes from a site A to a site B, the program installed on the departure site generates a click-through event.

In the case in which the user carries out purchases on site B, an affiliate's management mechanism enables site A to be notified by a per-sale event.

Management of the click-through is realized in attachment D. Attachment E describes the possible processing handling of the per-sale event which is technically more demanding.

The Negotiation Platform. The Technical Platform (Bidding on the Traffic)

The technical platform provides forward on its site a mechanism enabling the different client sites to negotiate the revenues by click-through or affiliate: The technical platform then generates a table (a switching chart) in which columns A−>B represent the financial conditions of the passage from site A to site B.

This passage is possible if the figures entered by B in the box A−>B of the table managed by the technical platform are accepted by A. This mechanism implements a bidding mechanism for the click-through and per-sale conditions between the two sites.

The Technical Platform Site: User Submission

The technical platform will have its own site accessible directly to the users (whereas the mechanism described in the preceding section applies to other Internet sites (called clients).

The principal functionality of this site will be the possibility for the user to submit to the technical platform database a request of the RETRIEVE type from an image which has not previously been submitting by an ADD procedure to the technical platform. These images can also be in the form of an image file on the disk. A submission mechanism by pulling, releasing can be proposed.

This retrieve functionality is different from that described in the preceding section. In the preceding case, calculation of the visual signature is performed at the moment of the ADD procedure and the RETRIEVE procedure merely finds in the database the signatures calculated in the ADD procedure. In the present case, the signature is calculated at the moment of the retrieve request. This procedure is referred to as RETRIEVE_NEW.

The preceding use scenarios imply that the images of the site that the user is visiting were preprocessed by the server or that the user submits them to the technical platform site.

The use of a plug-in module present as background task of the processing system provides the user with the possibility of clicking on any image of a site even if the visited site is not a client of the technical platform (in other words, the image was not previously submitted by an ADD procedure). This can be implemented from the site without passing through the user submission site of the technical platform.

The plug-in module can be downloaded from the technical platform site and certain client sites. In summary, such a request can be broken down into:

communication between the Internet browser and the plug-in module to recover the requested image.

calling up the RETRIEVE_NEW procedure.

display by the plug-in module of the results sent by the technical platform server.

Certain users, e.g., collectors, are looking for images of a certain type (e.g., images of Egyptian statues).

The technical platform provides these clients with the possibility of equipping their site with SUBSCRIPTION functionality. This functionality will also be available directly on the technical platform submission site.

In a SUBSCRIPTION event, the technical platform database recognizes that a user of a client (the client can be the technical platform user submission site itself) desires to be notified when new images similar to the image attached to the event are added to the technical platform database.

When an ADD event arrives at the technical platform database, the technical platform system scans its SUBSCRIPTION base to see if a similar image is present. In this case, the site is notified (if the site which submitted it is compatible in terms of switching with the client site) by a NOTIFY_SUBSCRIBER.

Another variant of the invention concerns the RELEVANCE_FEEDBACK procedure enabling user profiling.

The client site has the possibility of providing feedback to the database regarding the user's satisfaction with the content sent by the technical platform in the NOTIFY_SUBSCRIBER procedure. The value is to be able to use feedback relevance technology and thereby offer the user images of increasing pertinence. This will be achieved by means of the RELEVANCE_FEEDBACK procedure.

In practical terms, when an art auction site employs the invention, this procedure allows its users to be notified when objects come up for sale on the site which are similar to those that the users have previously purchased. This has the advantage of targeting the user.

Several days later, a similar object can be offered to the user. If the user judges that this object corresponds to that which is sought, the user will so inform the auction site, which will so inform the technical platform by means of the RELEVANCE_FEEDBACK procedure.

Another variant of implementation concerns subscription sites for the development of clients supporting the technical platform.

Moreover, the auction site could install subscription positions on content sites, e.g., the Louvre's Web site for example. Naturally, the targeted site would be reimbursed for carrying the subscription position of the auction site and the technical platform can possibly share in this remuneration.

This mechanism falls within the scope of a more general mechanism comprised of providing electronic commercial sites with the means of equipping content sites with the technology of the technical platform to generate traffic.

Use of Mobile Phones

The latest developments in mobile phone technology allow integration of a minicam or digital camera. By enabling users of digital cameras to send their photos directly to the user submission site of the technical platform described above and enabling impulse purchases, no longer just for images on a Web browser but for the user looking at real objects. After having transformed images on the Web into shop windows, the technical platform can then transform an object into a shop window.

One particular mode of implementation of the invention consists of automating the retrieval of similar graphical objects. This variant consists of offering users a subscription function comprised of recording on a server objects extracted from the image and selected by a user, and of periodically activating retrieval by comparison of these objects with those contained in the database, and of sending the user the positive results of this periodic retrieval.

According to another variant of the invention, the user has a means for accepting or refusing the objects from the database having a similar signature. The result of this selection is exploited to optimize the similarity criteria by the construction of a profile evolving on the basis of successive iterations.

To reduce the calculation time and improve the quality of the results, one variant consists of recording in a buffer memory (cache memory) the codes of the images that have already been analyzed and the list of the similar associated images, these similar images resulting from a prior analysis. Any new image presented is compared with the images recorded in the buffer memory by means of the aforementioned code. If the image was already analyzed by the system, the results are returned by the system without supplementary calculation.

The buffer memory can be the memory of the workstation. It can also be constituted by a remote server acting as a proxy and centralizing the codes and the associated similar images for a multiplicity of users.

In the opposite case, the usual processing is applied to the unknown image.

The description below pertains to a variant of implementation in which the process comprises an intermediate recognition operation.

This operation is intercalated between the aforementioned object-extraction step (4, 5) and the step comprising retrieval by visual similarity (8).

This step consists of recognizing the membership category of the objects (5) originating from the object-extraction step (4) or of offering an operator a list of probable object categories. The operator proceeds to a selection of objects on the list to prepare a request for retrieval on the subset of images corresponding to the selected category.

This operation thus consists of:

offering the operator a list of graphical objects grouped together in categories each of which is summarized by a graphical symbol representative of the category under consideration,

enabling the operator to select one of these categories,

proceeding to retrieval by visual similarity among the images of the selected category.

This operation reduces the retrieval time by limiting retrieval to a subset of images, and improves the quality of the result because of this preselection step.

This operation also improves the ergonomics of the use of the process because of the structuring of the retrieval.

One particular application of the invention consists of automating the loading of a result page containing images similar to the image containing the searched-for object. For this purpose, the operator sends a request containing the initial image and receives in return a result page without any other intermediary manual intervention.

1. A process for presenting information in a multimedia file from a query implemented by a user on an open computer network comprising a multiplicity of computer terminals enabling transmission of graphical data displayed in multimedia files, said process comprising:
a) selecting at least one image comprising an object to be retrieved;
b) adaptively analyzing a global image to isolate a zone of interest comprising a graphical element which is an object of a query and calculating a set of visual signatures for each object;
c) comparing visual signatures of extracted objects and images contained in the multimedia files to find similar objects stored in said multimedia files; and
d) constructing a file comprising a set of responses resulting from the comparison.

2. The information presentation process according to claim 1, wherein selecting images containing the object to be retrieved is constituted by a query keyed in by the user, said query comprising a zone designated by the user.

3. The information presentation process according to claim 1, wherein selecting images containing the object to be retrieved is constituted by an automatic analysis of a multiplicity of multimedia documents.

4. The information presentation process according to claim 1, further comprising defining a specific zone for an image from which objects are extracted, the specific zone being determined automatically in a manner specific to each image analyzed.

5. The information presentation process according to claim 1, wherein a set of keywords is associated with each object stored in the multimedia file and a file containing the set of responses comprises the keywords associated with a set of objects that are similar to the objects extracted from the at least one image.

6. The information presentation process according to claim 5, wherein text databases are interrogated using the keywords.

7. The information presentation process according to claim 1, wherein text databases are interrogated using keywords defined during extracting.

8. The information presentation process according to claim 1, wherein extracting the objects contained in the at least one image is performed at a source prior to putting pages containing the at least one image online.

9. The information presentation process according to claim 1, wherein extracting the objects contained in the at least one image is performed at a finish point subsequent to loading of a page containing the at least one image.

10. The information presentation process according to claim 1, further comprising automating retrieval of similar graphical objects which consists of recording on a server objects extracted from the image and selected by a user, and periodically activating retrieval by comparison of the objects with those contained in the multimedia files, and sending the user positive results of the periodic retrieval.

11. The information presentation process according to claim 1, further comprising selectively allowing the user to accept or refuse objects from the multimedia files having a similar signature, the result of this selection being exploited to optimize similarity criteria by construction of a profile evolving on the basis of successive iterations.

12. The information presentation process according to claim 1, further comprising acquiring an image by digital camera to enable transmission of photos directly to a submission site.

13. The information presentation process according to claim 1, further comprising recognizing by retrieving membership of objects originating from step b) or of offering an operator a list of probable object categories consisting of preparing a selection of objects on the list to prepare a request for retrieval on a subset of images corresponding to a selected category.

14. The information presentation process according to claim 13, wherein recognizingly retrieving consists of:
offering the operator a list of graphical objects grouped together in categories each of which is summarized by a graphical symbol representative of the category under consideration;
enabling the operator to select one of these categories; and
proceeding to retrieval by visual similarity among images of the selected category.

15. An interface comprising an image delimitation means and an image transmission means for implementation of the process according to claim 1.

16. A process for presenting information in a multimedia file from a query implemented by a user on an open computer network comprising a multiplicity of computer terminals enabling transmission of graphical data displayed in multimedia files, said process comprising:
a) selecting at least one image comprising an object to be retrieved;
b) extracting objects contained in the at least one image;
c) comparing objects contained in the at least one image with images contained in the multimedia files; and
d) constructing a file comprising a set of responses resulting from the comparison.

17. Process for presentation of information in a multimedia file from a query implemented by a user on an open computer network comprising a multiplicity of computer terminals enabling transmission of graphical data displayed in multimedia files, said process comprising a step of selecting at least one image comprising an object to be retrieved, a query processing step, a database interrogation step based on this query, a step of constructing a file comprising the set of responses associated with this query, characterized in that
the processing step consists of an adaptive analysis of the global image in order to isolate a zone of interest comprising a graphical element which is the object of a query and of calculating a set of visual signatures for each object,
the database interrogation step comprises a step of comparing the visual signatures of the extracted objects and the images contained in the database in order to find the similar objects stored in said database.
